(19) United States
(12) Patent Application Publication
(10) Pub. No.: US 2008/0030331 A1
(43) Pub. Date: Feb. 7, 2008

(54) ANTI-THIEF ELECTRONIC DEVICE AND METHOD THEREOF

(75) Inventors: Sun-chung Chen, Shijr City (TW); Shih-yuan Huang, Shijr City (TW); Chein-chung Chen, Shijr City (TW); Chien-wen Yu, Shijr City (TW)

Correspondence Address: MADSON & AUSTIN, 15 WEST SOUTH TEMPLE, SUITE 900, SALT LAKE CITY, UT, 84101, US

(73) Assignee: Aten International Co., Ltd., Shijr City (TW)

(21) Appl. No.: 11/462,650

(22) Filed: Aug. 4, 2006

(51) Int. Cl. G08B 13/14; G06F 11/00; G08B 21/00

(52) U.S. Cl. 340/568.2; 340/686.1; 726/35

(57) ABSTRACT

An anti-thief electronic device capable of confirming respective existing statuses of a plurality of apparatuses coupled thereto and method thereof is disclosed. The anti-thief electronic device includes a first table, a second table, a micro control unit and an alert device. The first table stores respective initial existing statuses of the apparatuses coupled to the anti-thief electronic device as regular existing statuses. The second table stores respective existing statuses of the apparatuses periodically. The micro control unit periodically compares the second table with the first table to confirm whether the respective existing statuses of the apparatuses are changed or not. The alert device generates an alert if the respective existing statuses of the apparatuses are changed. Specifically, the micro control unit periodically queries an extended display identification data from the display for detecting the removal of the display.

### FIELD OF THE INVENTION

The present invention generally relates to an anti-thief electronic device, and more particularly to an anti-thief electronic device capable of confirming existing statuses of a plurality of apparatuses coupled thereto and method thereof.

### BACKGROUND OF THE INVENTION

Today, an anti-thief function has become an important topic and an essential for many electronic devices, such as computers, displays. These electronic devices may usually be set up for demonstrations at the booth in an exhibition, in a market in a showroom or in a shop, where always a crowd gathers and the crowded moment will be the best timing for a thief to steal these electronic devices. Therefore, most of these electronic devices are designed to have an anti-thief function. Traditionally, a security lock to lock the electronic device to the table where the electronic device set up or some other places near around is an economical option. However, it's a passive way against thief and cannot inform the owner who is in charge of the booth for the electronic devices in an exhibition, in a market or in a shop.

The related arts disclosed in U.S. Pat. No. 5,034,723, U.S. Pat. No. 5,525,965 or U.S. Pat. No. 5,821,868 discloses a circuit design, which detects the power supply of the electronic device. Such circuit design is generally combined with the power wire or set up at the plug of the power line. Once the electronic device is carried away from the power supply, such circuit will buzz by a buzzer or indicate a warning by a red lamp for the disconnecting status of the power supply. However, the owner needs to prepare such one circuit production for each electronic device and set them up one by one. It is very troublesome to the owner of the booth. Furthermore, it's still not good enough to inform the owner who is in charge of the booth for the electronic devices in an exhibition, in a market or in a shop. Such as a plurality of displays and some computers are set up in the booth and coupled with a keyboard-video-mouse switch, which is in a remote control room where the corresponding computers of the displays are and the remote control room is far away from the booth. An alert like the aforesaid buzzer or warning red lamp, which detects the power supply of the displays or computers are around those displays or computers, i.e. near the booth. However, the buzzing or the warning red lamping has to be happened in the remote control room. Otherwise, the alert means nothing.

Consequently, there is a need to develop an anti-thief electronic device capable of confirming existing statuses of a plurality of apparatuses coupled thereto and method thereof. Meanwhile, such anti-thief electronic device can be designed to generate an alert by itself or even designed to transmit the alert through a network to notify the owner such as an email or a message for a mobile phone that the owner carries about if the anti-thief electronic device can get Internet access.

### SUMMARY OF THE INVENTION

To solve the foregoing drawbacks in the prior art, it is an objective of the present invention is to provide an anti-thief electronic device capable of confirming respective existing statuses of a plurality of apparatuses coupled thereto and method thereof.

Another objective of the present invention is to provide an anti-thief electronic device capable of detecting an existing status of a display coupled thereto and method thereof.

To solve the foregoing drawbacks in the prior art, it is an objective of the present invention is to provide an anti-thief electronic device capable of confirming respective existing statuses of a plurality of apparatuses coupled thereto and method thereof. The anti-thief electronic device includes a first table, a second table, a micro control unit and an alert device. The first table stores respective initial existing statuses of the apparatuses coupled to the anti-thief electronic device as regular existing statuses. The second table stores respective existing statuses of the apparatuses periodically. The micro control unit periodically compares the second table with the first table to confirm whether the respective existing statuses of the apparatuses are changed or not. The alert device generates an alert if the respective existing statuses of the apparatuses are changed.

The anti-thief electronic device further includes a memory for saving the first table and the second table. Furthermore, the values in the first table corresponding to the respective initial existing statuses are inputtable for a user. The apparatus coupled with the anti-thief electronic device can be a peripheral, such as a keyboard, a mouse, a display, a computer or a network equipment. The micro control unit can obtain an existing status of the display by querying an extended display identification data (EDID) via display data channel (DDC) from the display. Meanwhile, the micro control unit can obtain an existing status of the keyboard or of the mouse by sending an echo command to the keyboard or the mouse. The way that the micro control unit obtains an existing status of the network equipment is by detecting a carrier of linking the network equipment.

The anti-thief electronic device of present invention can be a keyboard-vide-mouse switch, a keyboard-vide-mouse extender, a video extender or a video splitter.

The present invention provides a method of anti-thief for a plurality of apparatuses coupled to an anti-thief electronic device to accomplish the above object.

The method comprises the steps of:

obtaining the respective existing statuses of the apparatuses;

storing respective initial existing statuses of the apparatuses coupled to the anti-thief electronic device as regular existing statuses in a first table;

storing respective existing statuses of the apparatuses in a second table periodically;

periodically comparing the second table with the first table to confirm whether the respective existing statuses of the apparatuses are changed or not; and

generating an alert if the respective existing statuses of the apparatuses are changed.

Before the step of obtaining the respective existing statuses of the apparatuses, the method further includes steps for obtaining the respective existing statuses:

querying an extended display identification data via a display data channel from a display to obtain an existing status thereof;

sending an echo command to a keyboard or a mouse to obtain an existing status thereof; and

detecting a carrier of linking a network equipment to obtain an existing status thereof.

Specifically, values corresponding to the respective initial existing statuses in the first table are inputtable for a user.

According to the present invention, the anti-thief electronic device can periodically confirms the respective existing statuses of the apparatuses coupled thereto and provides the anti-thief function efficiently prevent a thief.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a functional block diagram of an anti-thief keyboard-mouse-video switch according to the present invention;

FIG. 2 shows contents of a first table and a second table employed as one embodiment in the anti-thief electronic devices according to the present invention;

FIG. 3 illustrates a functional block diagram of an anti-thief keyboard-vide-mouse extender according to the present invention;

FIG. 4 illustrates a functional block diagram of an anti-thief video extender according to the present invention;

FIG. 5 illustrates a functional block diagram of an anti-thief video splitter according to the present invention;

FIG. 6 illustrates a detail block diagram of a circuit 500 shown in FIG. 5;

FIG. 7 shows a flow chart of the method of anti-thief according to the present invention; and

FIG. 8 shows a flow chart of a flow chart of a method of anti-thief for a display by detecting a removal of the display according to the present invention.

### DETAILED DESCRIPTION OF THE PREFERRED EMBODIMENTS

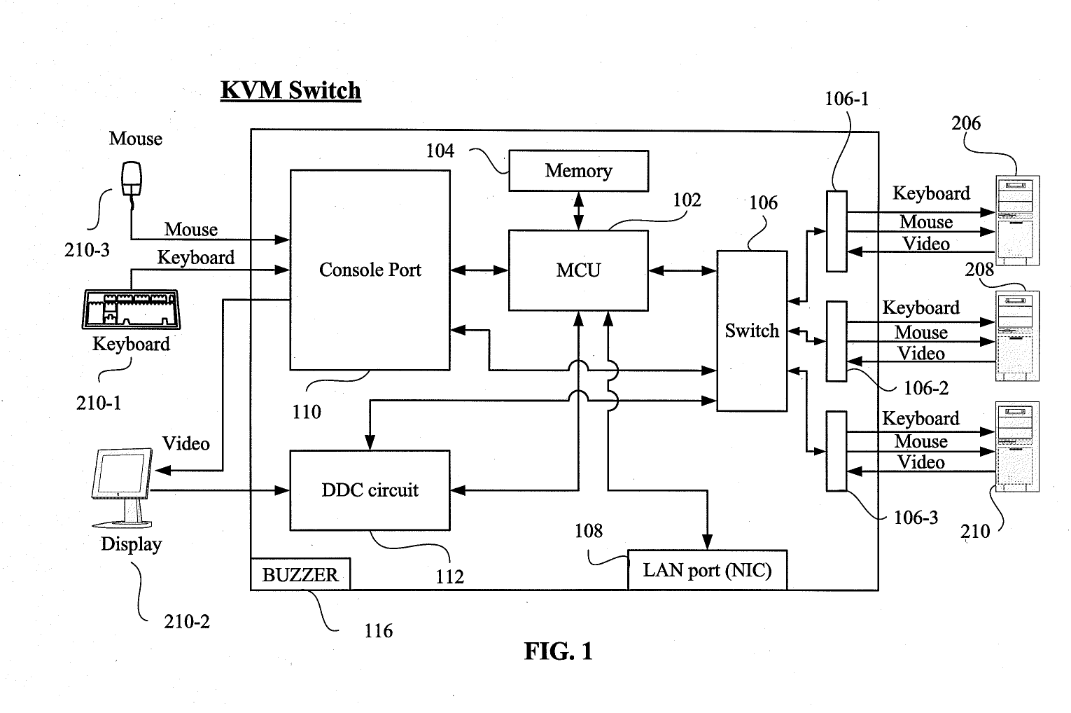

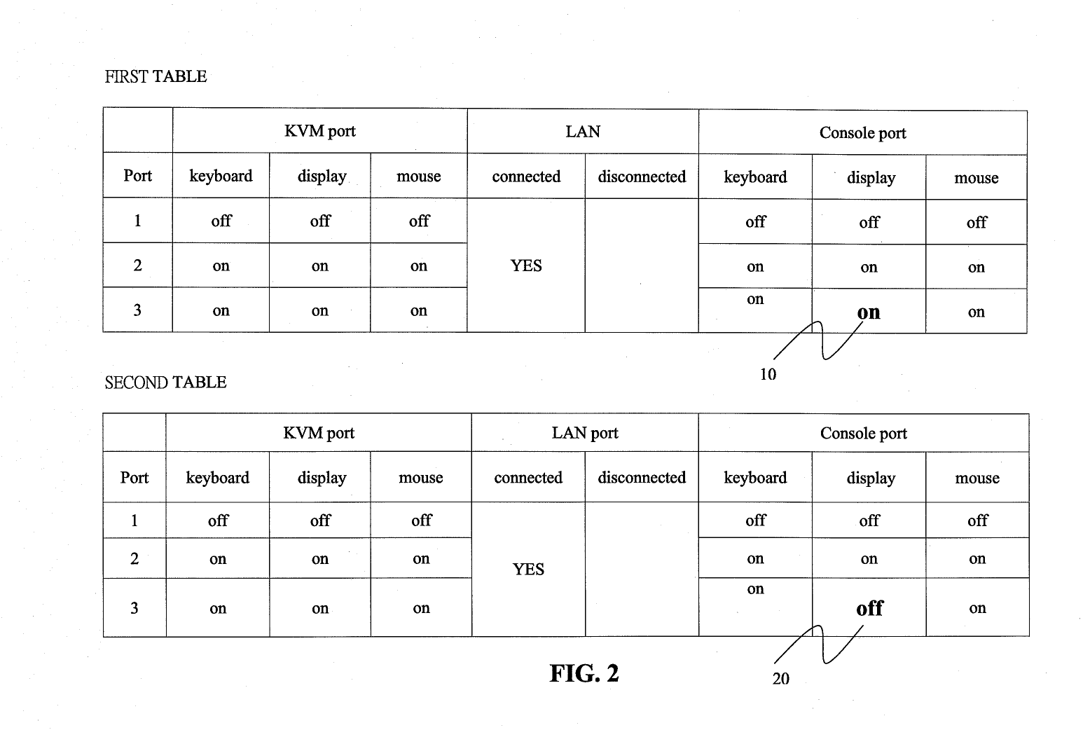

Please refer to FIG. 1 with FIG. 2. FIG. 1 is an illustration of a functional block diagram of an anti-thief keyboard-mouse-video (KVM) switch according to the present invention. FIG. 2 shows contents of a first table and a second table employed as one embodiment in the present anti-thief electronic devices. The anti-thief keyboard-mouse-video switch includes a micro control unit (MCU) 102, a memory 104, a switch 106, a LAN port (NIC) 108, a console port, a Display Data Channel (DDC) circuit 112, and a buzzer 116. The switch 106 is coupled to a computer 206 with a KVM port 106-1 to transmit a keyboard signal, a mouse signal to the computer 206 and to receive a video signal from the computer 206. Meanwhile, the switch 106 also can transmit a keyboard signal, a mouse signal to the computer 208 and receive a video signal from the computer 208 via a KVM port 106-2; also can transmit a keyboard signal, a mouse signal to the computer 210 and receive a video signal from the computer 210 via a KVM port 106-3. All the KVM ports 106-1, 106-2 and 106-3 have respective a keyboard port, a mouse port and a video port for transmitting or receiving signals respectively. The console port, coupled with a keyboard 210-1, a display 210-2 and a mouse 210-3, receives the keyboard signal, the mouse signal from the keyboard 210-1, the mouse 210-3 and transmits the video signal to the display 210-2. Meanwhile, the DDC circuit 112 receives an extended display identification data (EDID) via display data channel (DDC) from the display 210-2. The LAN port 108 coupled with a network equipment (which is not shown) transceives carriers of data to/from the network equipment. The DDC circuit 112 is employed to communicate with the computers 206, 208 coupled with the KVM switch and the display 210-2 complying the VESA standard. For example, the DDC circuit 112 receives the query command of display manufacturer, type, specification information data and other information data from the computer 206 and transmits the query command to the display to obtain the aforesaid data, such as, the extended display identification data (EDID), and then sends them back to the computer 206. Specifically, if the micro control unit 102 is an ASIC, the DDC circuit 112 can be embedded into the micro control unit 102. Alternatively, the MCU 102 replaces the DDC circuit 112 to send the query command to the display 210-2 and replies one of the computers 206, 208 for the display 210-2, and thus the DDC circuit 112 can be omitted.

According to the present invention, the micro control unit 102 of the anti-thief KVM switch obtains respective initial existing statuses of the apparatuses (the computer 206, computer 208, the keyboard 210-1, the display 210-2, the mouse 210-3 and the network equipment) coupled thereto by a user's command and stores the respective initial existing statuses in a first table as regular existing statuses shown in FIG. 2. The leftest column filled in as “port” with number 1, 2, and 3 represents the anti-thief KVM switch can be coupled with a plurality of computers and a plurality of consoles. The micro control unit 102 of the anti-thief KVM switch periodically obtains respective existing statuses of the apparatuses to store the respective existing statuses in a second table shown in FIG. 2. The first and second tables are preferably stored in the memory 104. If the micro control unit 102 is an ASIC having a memory, storing the first and second tables in the memory inside the micro control unit 102 also can be an option.

The micro control unit 102 periodically compares the second table with the first table to confirm whether the respective existing statuses of the apparatuses are changed or not, as shown in FIG. 2. The regular status of the display belong to port number 3 in first table is “on” indicated as 10 but the existing status in second table is changed to be “off” indicated as 20. Accordingly, the alert device, such as the buzzer 116, will generate an alert buzzing, or such as a special program in MCU 102, will send a warning message or a notice e-mail through the LAN port 108 to a mobile device carried by the user according to predetermined setting to the anti-thief KVM switch by the user. If any of the existing statuses in second table is changed in comparison with the first table, the alert device, such as the buzzer 116 will buzz or such as a special program in MCU 102, will send a warning message or a notice e-mail to the user.

Specifically, the micro control unit 102 obtains an existing status of the display 210-2 by querying the extended display identification data (EDID) via display data channel (DDC) from the display 210-2. The micro control unit 102 obtains an existing status of the keyboard 210-1 or the mouse 210-3 by sending an echo command to the keyboard 210-1 or the mouse 210-3. The micro control unit 102 obtains an existing status of the network equipment (which is not shown) coupled with the LAN port 108 by detecting a carrier of linking the network equipment. Meanwhile, the micro control unit 102 can obtain an existing status of the computer 206 by detecting a power presence in the keyboard port of the switch 106. Alternatively, detecting a power presence in the mouse port of the switch 106 from the computer 206 or detecting a synchronization signal presence in the video signal from the computer 206 also can be implemented to obtain the existing status of the computer 206.

Furthermore, the values corresponding to the respective initial existing statuses in the first table are inputtable for a user. For example, if the user wants to remove the display 210-2 coupled to the anti-thief keyboard-mouse-video (KVM) switch, the user can change the initial existing status of the display 210-2 in the first table in advance and then remove the display to avoid the alert generated by the alert device.

Alternatively, for detecting removal of the display 210-2 only, the DDC circuit 112 or the micro control unit 102 periodically sends a querying command via display data channel to the display 210-2. The micro control unit 102 determines whether a response from the display is retrieved or not. If the response is not retrieved, the micro control unit 102 considers that the display 210-2 has been removed from the KVM switch.

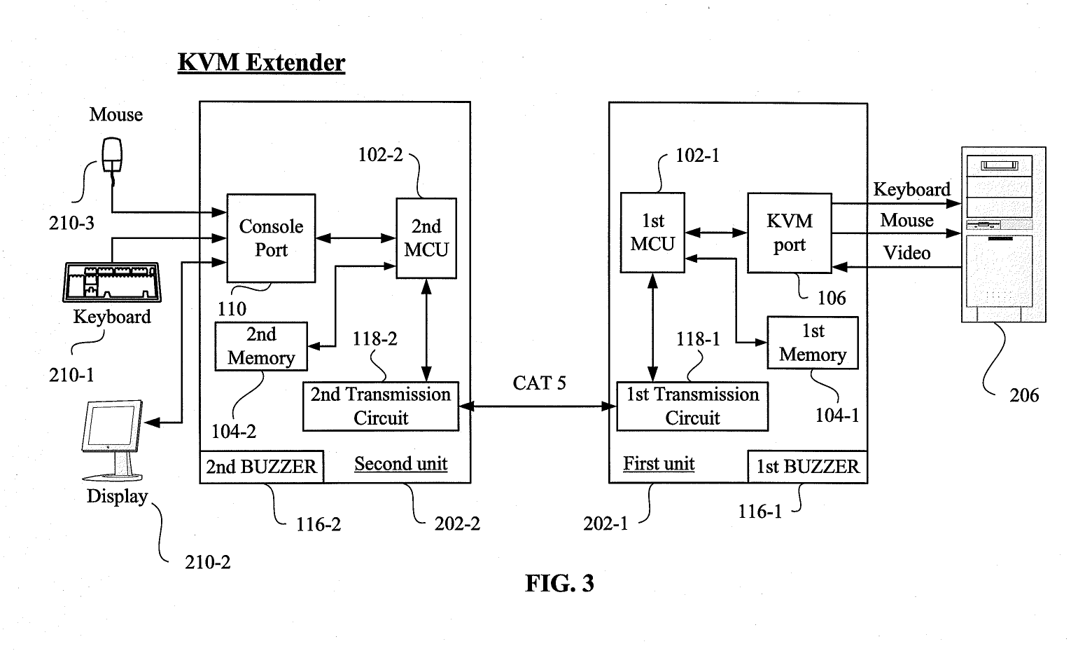

Please refer to FIG. 3, which illustrates a functional block diagram of an anti-thief keyboard-vide-mouse extender according to the present invention. The keyboard-video-mouse extender includes a first unit 202-1 and a second unit 202-2. The first unit 202-1 includes a first micro control unit (MCU) 102-1, a first memory 104-1, a KVM port 106, a first buzzer 116-1 and a first transmission circuit 118-1. The second unit 202-2 includes a second micro control unit (MCU) 102-2, a second memory 104-2, a console port 110, a second buzzer 116-2 and a second transmission circuit 118-2. The first unit, coupled with a computer 206 via the KVM port 106, transmits a keyboard signal, a mouse signal to the computer 206 and receives a video signal from the computer 206. The second unit 202-1, coupled with a keyboard 210-1, a display 210-2 and a mouse 210-3 via the console port 110, receives the keyboard signal, the mouse signal from the keyboard 210-1, the mouse 210-3 and transmits the video signal to the display 210-2. The first unit 202-1 and the second unit 202-2 are connected with each other via the first transmission circuit 118-1, the second transmission circuit 118-2 and a transmission cable inbetween. In this embodiment, the transmission cable is a CAT5 cable. Specifically, a DDC circuit for receiving an extended display identification data (EDID) via the DDC from the display 210-2 is embedded in the first micro control unit 102-1 or the second micro control unit 102-2 in this embodiment. Alternatively, DDC circuit also can be separated from the micro control units (MCU) as similarly described in FIG. 1.

The second micro control unit 102-2 obtains an existing status of the display 210-2 by querying the extended display identification data (EDID) via display data channel (DDC) from the display. The second micro control unit 102-2 obtains an existing status of the keyboard 210-1 or the mouse 210-3 by sending an echo command to the keyboard 210-1 or the mouse 210-3. Meanwhile, the first micro control unit 102-1 can obtain an existing status of the computer 206 by detecting a power presence in the keyboard port. Alternatively, detecting a power presence in the mouse port or detecting a synchronization signal presence in the video port also can be implemented to obtain the existing status of the computer 206.

The first table storing the respective initial existing statuses of the computer 206, keyboard 210-1, the display 210-2 and the mouse 210-3 as regular existing statuses and the second table periodically storing the respective existing statuses can be located in the first memory 104-1 or the second memory 104-2 by predetermining that the anti-thief function is set up mainly in the first unit 202-1 or the second unit 202-2 by a designer of the anti-thief keyboard-vide-mouse extender. Accordingly, the first micro control unit 102-1 or the second micro control unit 102-2 periodically compares the second table with the first table to confirm whether the respective existing statuses of the coupled apparatuses (the computer 206, the keyboard 210-1, the display 210-2 and the mouse 210-3) are changed or not. If any of the respective existing statuses is changed, the alert device, such as the buzzer 116-1 or the buzzer 116-2, will generate an alert buzzing. Of course, they can preferably buzz at the same time.

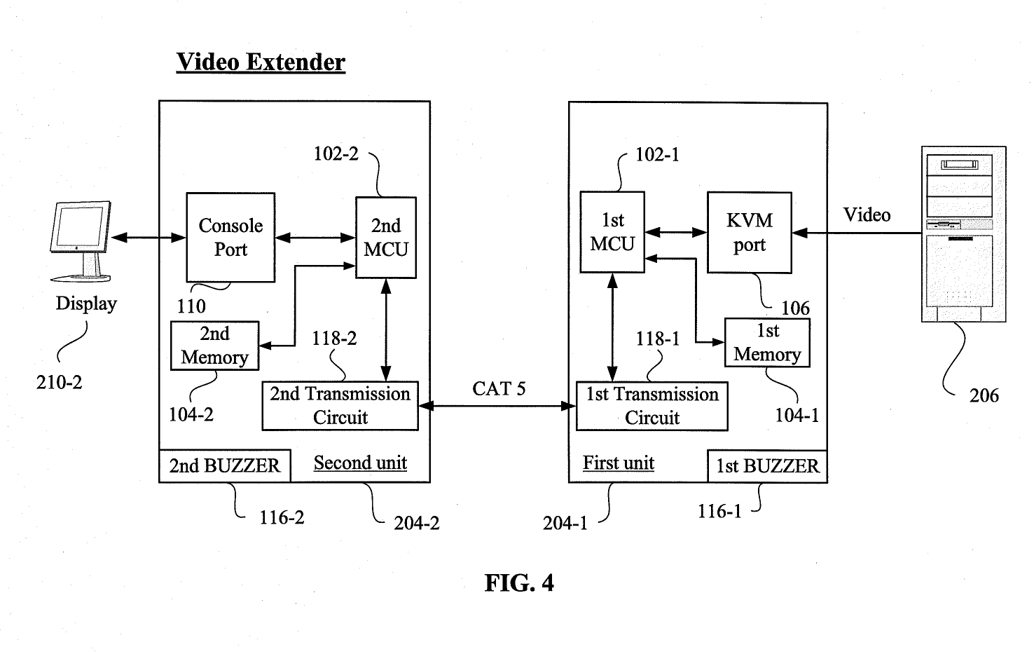

Please refer to FIG. 4, which illustrates a functional block diagram of an anti-thief video extender according to the present invention. Similarly as described in FIG. 3, A DDC circuit can be embedded in the second micro control unit 102-2 or can be separated from the second micro control unit 102-2. The DDC circuit or the second micro control unit 102-2 of the anti-thief video extender periodically sends a querying command via display data channel to the display according to the command of the second micro control unit 102-2. The second micro control unit 102-2 determines whether a response from the display is retrieved or not. The response is the same as aforementioned KVM switch shown in FIG. 1, an extended display identification data (EDID) complying with the VESA standard. If the EDID is not retrieved, the second micro control unit 102-2 considers that the display 210-2 has been removed from the KVM switch. An alert device such as a first buzzer 116-1 or a second buzzer 116-2 will generate an alert buzzing as an alert. The first micro control unit 102-1 can obtain an existing status of the computer 206 by periodically detecting a synchronization signal presence in the video signal from the computer 206. If the synchronization signal is absent, the first micro control unit 102-1 will consider that the computer 206 is removed from the KVM switch. An alert device such as a first buzzer 116-1 or a second buzzer 116-2 will generate an alert buzzing as an alert. Of course, they can preferably buzz at the same time. Furthermore, the anti-thief function can be predetermined to be set up mainly in the first unit 204-1 or the second unit 204-2 by a designer of the anti-thief video extender, therefore, the first micro control unit 102-1 or the second micro control unit 102-2 will be mainly in charge of the detection of the anti-thief function.

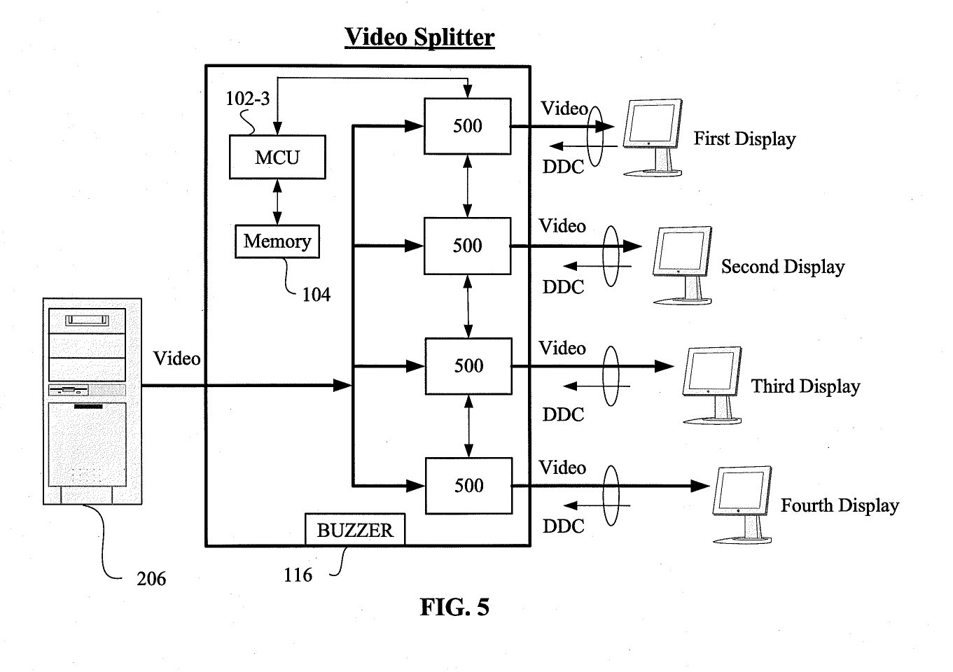

Please refer to FIG. 5, which illustrates a functional block diagram of an anti-thief video splitter according to the present invention. The anti-thief video splitter receives a video signal from a computer 206 and split the video signal to the first, second, third and fourth displays. The anti-thief video splitter includes a micro control unit 102-3, a memory 104 and four video process circuits 500 corresponding to the four displays, and a buzzer 116. The micro control unit 102-3 transmits the inputted, split video signal to the four video process circuits 500 to be amplified. Meanwhile, the micro control unit 102-3 of the video splitter obtains respective initial existing statuses of the first, second, third and fourth displays to be stored in a first table in the memory 104 as regular existing statuses by querying the extended display identification data (EDID) via display data channels (DDCs) from the first, second, third and fourth displays. After that, the micro control unit 102-3 periodically queries the extended display identification data (EDID) from the first, second, third and fourth displays to obtain the respective existing statuses thereof and store the respective existing statuses in a second table in the memory 104. The micro control unit 102-3 periodically compares the second table with the first table to confirm whether the respective existing statuses of the displays are changed. If any of the respective existing statuses of the displays is changed, the alert device, such as the buzzer 116 will generate an alert buzzing. Please note that in an alternative embodiment, the anti-thief video splitter includes a micro control unit 102-3, a memory 104 and a video process circuit 500 corresponding to the four displays, and a buzzer 116. The video process circuit 500 periodically sends a querying command via display data channel to the displays in turn. The micro control unit 102-3 determines whether a response from the displays is retrieved or not. If the response is not retrieved, the micro control unit 102-3 considers that one of the displays has been removed from the KVM switch, and thus alters a user or an administrator.

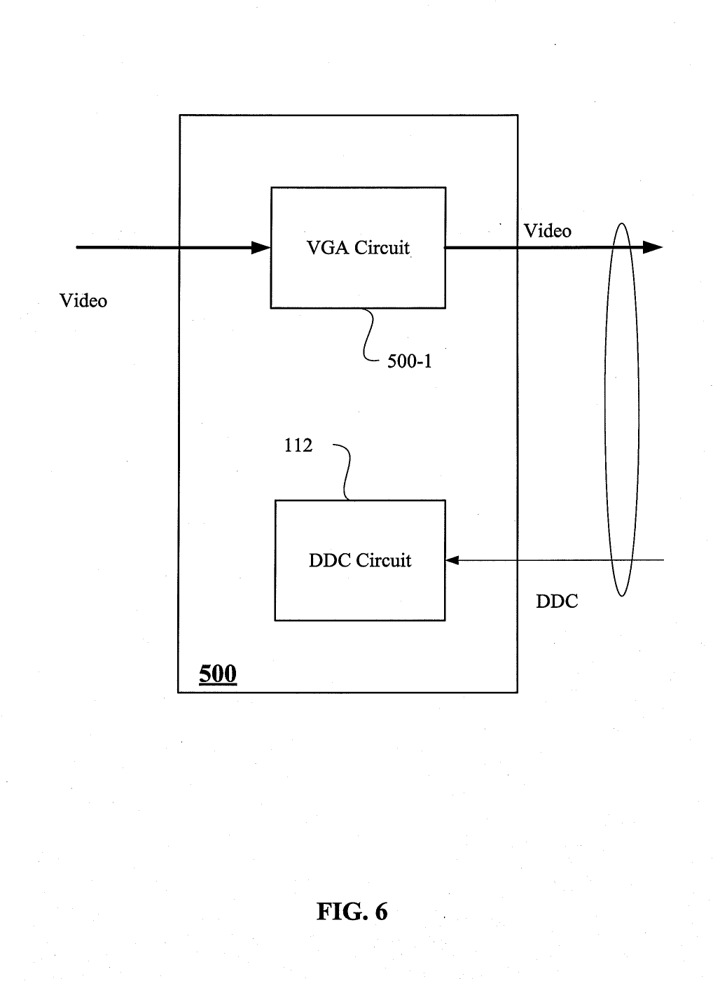

Please refer to FIG. 6, which illustrates a detail block diagram of a video process circuit 500 shown in FIG. 5. Each of the video process circuits 500 includes a VGA circuit 500-1 and a DDC circuit 112. The VGA circuit 500-1 amplifies the inputted, split video signal and transmits the amplified video signal to the corresponding display. The DDC circuit 112 receives an extended display identification data (EDID) via DDC from the corresponding display.

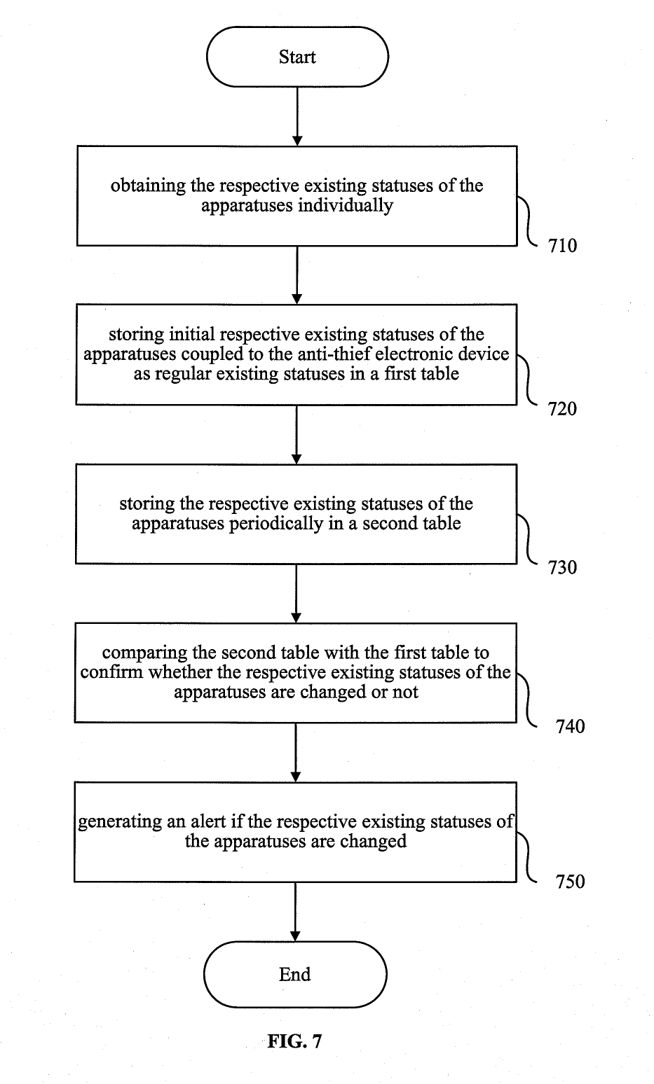

Please refer to FIG. 7, which depicts a flow chart of the method of anti-thief according to the present invention. The present invention provides a method of anti-thief for a plurality of apparatuses coupled to an anti-thief electronic device to accomplish the objectives of the present invention.

The present method includes the following steps:

Step 710, obtaining the respective existing statuses of the apparatuses;

Step 720, storing respective initial existing statuses of the apparatuses coupled to the anti-thief electronic device as regular existing statuses in a first table;

Step 730, storing respective existing statuses of the apparatuses in a second table periodically;

Step 740, periodically comparing the second table with the first table to confirm whether the respective existing statuses of the apparatuses are changed or not; and

Step 750, generating an alert if the respective existing statuses of the apparatuses are changed.

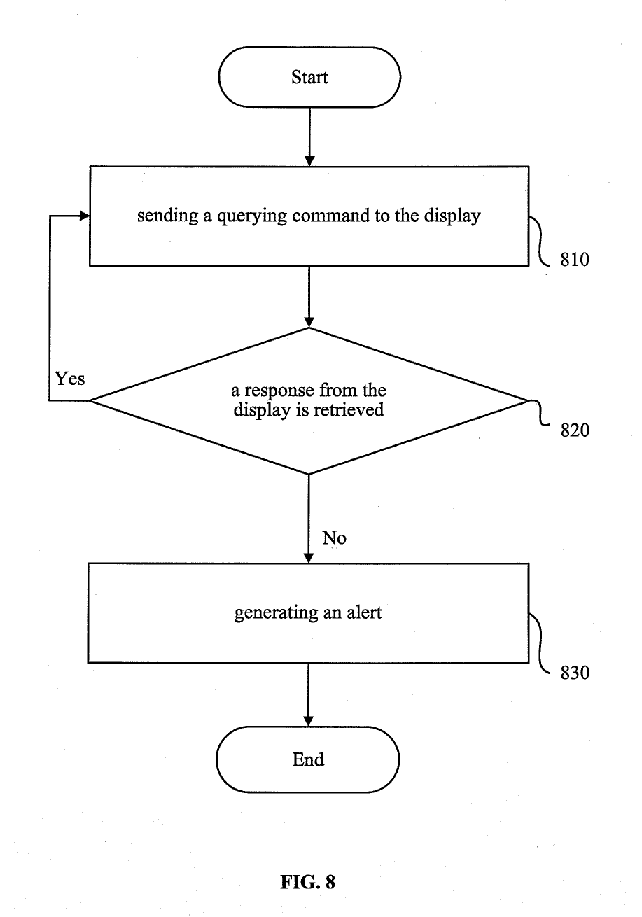

In case that the anti-thief electronic device is focused on detecting removal of a display coupled thereto, please refer to FIG. 8, which shows a flow chart of a method for anti-thief by detecting a removal of a display coupled to an anti-thief electronic device via a cable. The method includes the following steps:

Step 810, sending a querying command to the display;

Step 820, determining whether a response from the display is retrieved or not; if the response is retrieved, the method proceeds to the previous step; and

Step 830, generating an alert if response is not retrieved.

The querying command is sent via display data channel (DDC) to the display. What the querying command to obtain is an extended display identification data from the display. Generally, the cable can be a VGA cable.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. An anti-thief electronic device capable of confirming respective existing statuses of a plurality of apparatuses coupled thereto, the anti-thief electronic device comprising:
a first table, storing respective initial existing statuses of the apparatuses coupled to the anti-thief electronic device as regular existing statuses;
a second table, storing respective existing statuses of the apparatuses periodically;
a micro control unit, periodically comparing the second table with the first table to confirm whether the respective existing statuses of the apparatuses are changed or not; and
an alert device, generating an alert if the respective existing statuses of the apparatuses are changed.

2. The anti-thief electronic device of claim 1, wherein one of the apparatuses is selected from the group consisting of a keyboard, a mouse, a display, a computer and a network equipment.

3. The anti-thief electronic device of claim 2, wherein the micro control unit obtains an existing status of the display by querying an extended display identification data via a display data channel from the display.

4. The anti-thief electronic device of claim 2, wherein the micro control unit obtains an existing status of the keyboard by sending an echo command to the keyboard.

5. The anti-thief electronic device of claim 2, wherein the micro control unit obtains an existing status of the mouse by sending an echo command to the mouse.

6. The anti-thief electronic device of claim 2, wherein the micro control unit obtains an existing status of the network equipment by detecting a carrier of linking the network equipment.

7. The anti-thief electronic device of claim 1, further comprising a memory for saving the first table and the second table.

8. The anti-thief electronic device of claim 1, wherein values in the first table corresponding to the respective initial existing statuses are inputtable.

9. The anti-thief electronic device of claim 1 is selected from the group consisting of a keyboard-vide-mouse switch, a keyboard-vide-mouse extender, a video extender and a video splitter.

10. A method of anti-thief for a plurality of apparatuses coupled to an anti-thief electronic device by confirming respective existing statuses of the apparatuses, the method comprising steps of:
obtaining the respective existing statuses of the apparatuses;
storing respective initial existing statuses of the apparatuses coupled to the anti-thief electronic device as regular existing statuses in a first table;
storing respective existing statuses of the apparatuses periodically in a second table;
periodically comparing the second table with the first table to confirm whether the respective existing statuses of the apparatuses are changed or not; and
generating an alert if the respective existing statuses of the apparatuses are changed.

11. The method of claim 10, wherein one of the apparatuses is selected from the group consisting of a keyboard, a mouse, a display, a computer and a network equipment.

12. The method of claim 11, further comprising a step of querying an extended display identification data via a display data channel from the display to obtain an existing status of the display.

13. The method of claim 11, further comprising a step of sending an echo command to the keyboard to obtain an existing status of the keyboard.

14. The method of claim 11, further comprising a step of sending an echo command to the mouse to obtain an existing status of the mouse.

15. The method of claim 11, further comprising a step of detecting a carrier of linking the network equipment to obtain an existing status of the network equipment.

16. The method of claim 16, further comprising a step of inputting at least one of values corresponding to the respective initial existing statuses in the first table.

17. An anti-thief electronic device capable of detecting removal of a display coupled thereto via a cable, the anti-thief electronic device comprising:
a micro control unit, periodically sending a querying command to the display to determine whether a response from the display is retrieved or not; and
an alert device, generating an alert if the response data is not retrieved.

18. The anti-thief electronic device of claim 17, wherein the micro control unit sends the querying command via a display data channel to the display.

19. The anti-thief electronic device according to claim 17, wherein the response is an extended display identification data.

20. The anti-thief electronic device according to claim 17, wherein the cable is a VGA cable.

21. A method of anti-thief for a display by detecting removal of the display coupled to an anti-thief electronic device via a cable, the method comprising steps of:
periodically sending a querying command to the display;
determining whether a response from the display is retrieved or not; and
generating an alert if the response is not retrieved.

22. The method of claim 21, wherein the querying command is sent via a display data channel to the display.

23. The method of claim 21, wherein the response is an extended display identification data from the display for detecting the removal of the display.

24. The method of claim 21, wherein the cable is a VGA cable.
